(19) United States
(12) Patent Application Publication
(10) Pub. No.: US 2014/0328495 A1
(43) Pub. Date: Nov. 6, 2014

(54) SCULLCAP HEADGEAR WITH RECORDING AND PLAYBACK FEATURES

(71) Applicants: REFAEL IVRY, HAIFA (IL); SHLOMI SHALOM IVRY, HAIFA (IL)

(72) Inventors: REFAEL IVRY, HAIFA (IL); SHLOMI SHALOM IVRY, HAIFA (IL)

(21) Appl. No.: 14/201,802

(22) Filed: Mar. 8, 2014

Related U.S. Application Data
(60) Provisional application No. 61/818,599, filed on May 2, 2013.

(51) Int. Cl. H04R 1/02

(52) U.S. Cl. CPC H04R 1/02
USPC 381/87; 29/594

(57) ABSTRACT

Aspects of embodiments relate to a skullcap headgear comprising a skullcap body having a form such to be wearable by a head of a user and an audio system accommodated by the skullcap body. The audio system comprises an input device operative to receive a selection input from the user, an audio module and a processor for controlling the audio module such to be operative to determine an audible output responsive to the received selection input, and an output device operative to provide the audible output. In an embodiment, the headgear is a a yarmulke or kippa.

### CROSS-REFERENCE TO RELATED APPLICATIONS

This application claims the benefit of priority to U.S. Provisional Patent Application No. 61/818,599 filed on May 2, 2013, the disclosure of which is incorporated herein by reference in its entirety.

### TECHNICAL FIELD

Embodiments disclosed herein relate to apparel incorporating computing and/or electronic processing capabilities. Such apparel may hereinafter be referred to as a “wearable device”.

### BACKGROUND

In recent years, mobile electronic devices such as electronic tablet computers have gained significant popularity, as they have become increasingly affordable while at the same time providing ever more application possibilities.

One of the many applications of mobile electronic devices includes their use as a learning aid. A handheld mobile device may for instance be used to assist students, including children, in acquiring language skills. For example, responsive to a selection input of a visual representation of an object displayed on a device screen made by a user (e.g. a student), audible information descriptive of the selected object may be provided to the user in a selected language, Additional applications of mobile devices include assisting students in memorizing for instance text, quotations and/or sequences of musical notation like, e.g., a sequence of chords.

### SUMMARY

Aspects of embodiments relate to a skullcap headgear including, for example, a yarmulke or kippa. According to some embodiments, the skullcap headgear may comprise a skullcap body having a form such to be wearable by a head of a user, and an audio system accommodated by the skullcap body.

According to some embodiments, the audio system may comprise an input device operative to receive a selection input from the user, an audio module and a processor for processing data according to a set of instructions that may result in a playback application that determines an audible output responsive to the received selection input, and an output device operative to provide the audible output. Otherwise stated, the processor may control the audio module such to be operative to determine the audible output responsive to the received selection input.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting examples of embodiments disclosed herein are described below with reference to figures attached hereto that are listed following this paragraph. Identical and analogous structures, elements or parts that appear in more than one figure may be generally labeled with a same numeral in all the figures in which they appear. The drawings and descriptions are meant to illuminate and clarify embodiments disclosed herein, and should not be considered limiting in any way.

FIG. 1A shows a schematic perspective and partial cutaway view of an upper side of a skullcap headgear comprising the audio system, according to some embodiments;

FIG. 1B shows a schematic perspective view of an underside of the skullcap headgear of FIG. 1A, according to some embodiments;

FIG. 2 shows a block diagram illustration of an audio system, according to some embodiments; and

FIG. 3 shows a flow chart of a method for manufacturing the skullcap headgear, according to some embodiments.

### DETAILED DESCRIPTION

Aspects of embodiments relate to skullcap headgear that comprises an audio system and which therefore qualifies as a wearable device. The audio system is configured to provide, responsive to an input received (e.g., from a wearer of the skullcap headgear), an audible output that may assist the skullcap's wearer in reciting, for instance, religious prayers. The wearable device may thus have the functionality of a learning aid. The skullcap headgear disclosed herein may for example relate to a yarmulke, kippa or hech cap worn by Jewish men including children to fulfill the customary requirement that their head be covered, in particular while at prayer and when uttering blessings. Such skullcaps may sometimes also be worn by Jewish women affiliated for instance with conservative and reform communities. Correspondingly, the skullcap may be configured to assist in memorizing the recitation of prayers including, for example, prayers of the Jewish confession. Such prayers may also refer to the recitation of blessings.

It should be noted that the term “user” and “wearer” as used herein may be used interchangeably. Further, the expressions “operative to” and “configured to” may be used interchangeably.

In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended.

Unless otherwise stated, the use of the expression “and/or” between the last two members of a list of options for selection indicates that a selection of one or more of the listed options is appropriate and may be made.

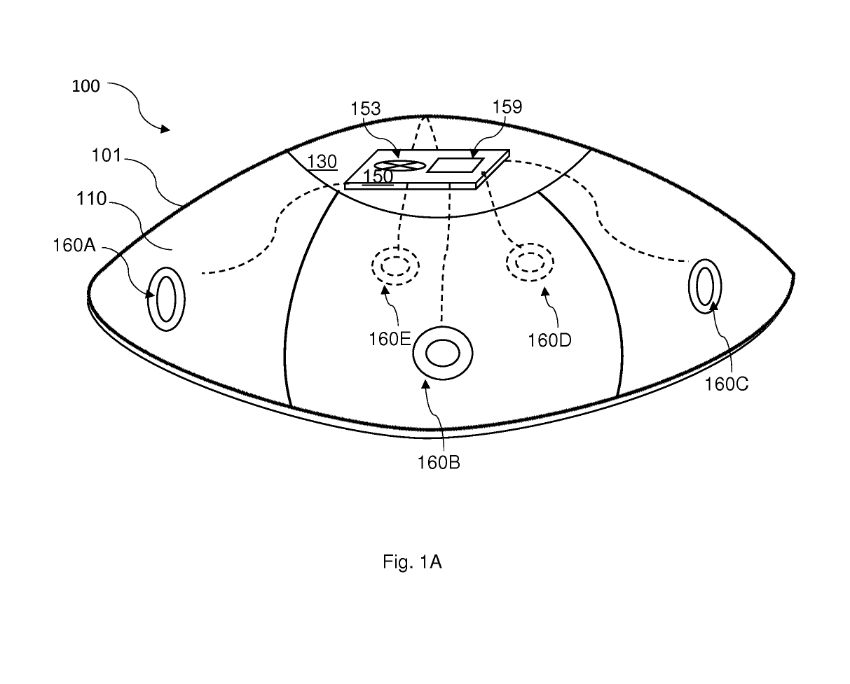

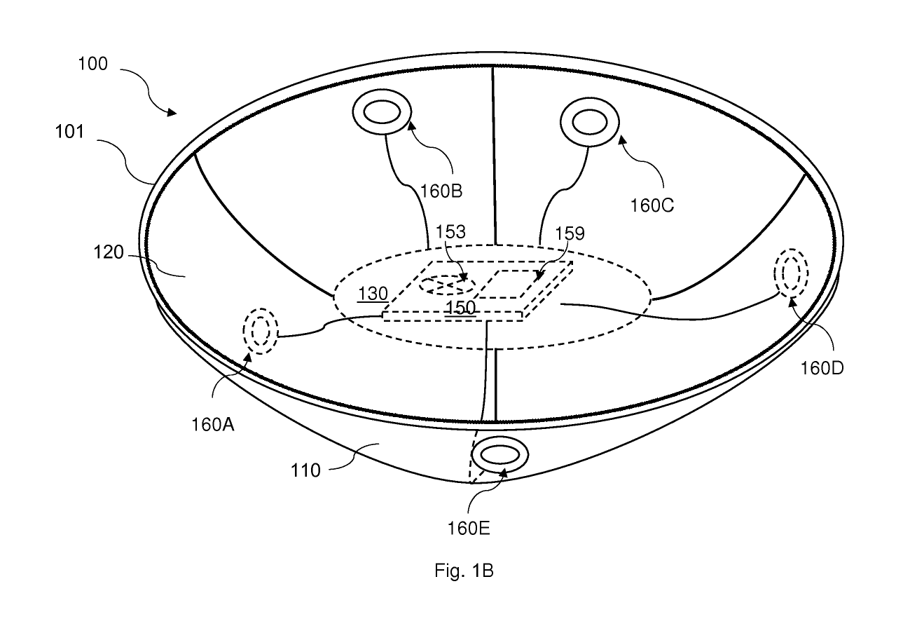

Reference is made now to FIGS. 1A and 1B. According to some embodiments, a headgear skullcap (hereinafter: skullcap) 100 such as, for example, a yarmulke or kippa, comprises a skullcap body 101 having a form such to be fittingly wearable by a user's head. Skullcap body 101 may for example be about platter-shaped or have the form of an about spherical cap and cover a surface area that may be smaller than that of a hemisphere. In some embodiments, skullcap body 101 may be about cup-shaped. Skullcap body 101 may have one more layers of material that may be made of any suitable animal-based, plant-based and/or synthetic material. Such material may include, for example, a textile fabric (which may be knitted or crocheted), suede, leather material, or any combination thereof. Skullcap body 101 may have an outer surface 110 that is outward facing with respect to a wearer's skull (not shown) and an inner surface 120 that is inward facing with respect to the wearer's skull, such that inner surface 120 may about fittingly engage with the user's head or skull. Skullcap body 100 may be configured to accommodate an audio system 150 operative to output or play audio content such as, for example, religious prayer, to the skullcap's wearer. Audio system 150 includes an output device 153 (e.g. one or more speakers) and a power module 159. Power module 159 may for example include a battery compartment and, optionally, the batteries received by the battery compartment.

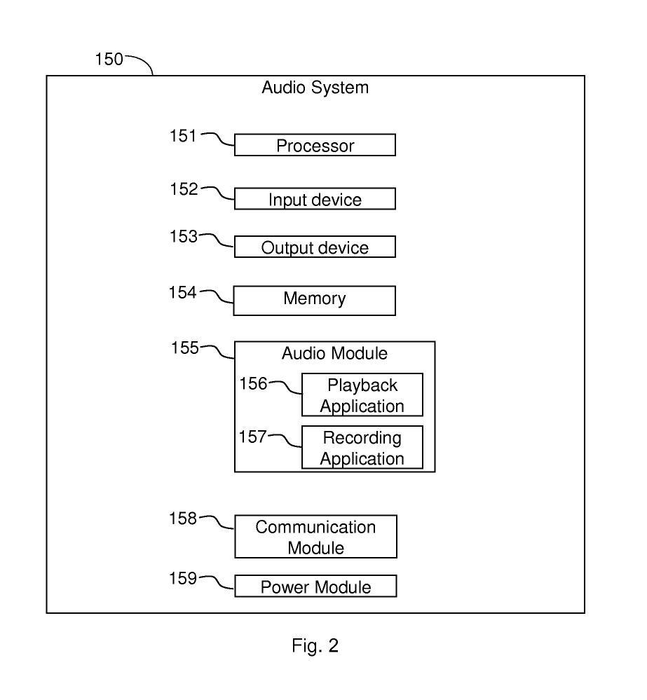

Additional reference is made to FIG. 2. According to some embodiments, audio system 150 may further include a processor 151, an input device 152, a memory 154 (which may include one or more computer readable storage media) and an audio module 155. The various components of audio system 150 may communicate with each other over one or more communication buses and/or signal lines (not shown). Power module 159 may enable powering the various components of audio system 150.

Processor 151, which may be embodied by one or more processors, may be configured to run or execute various sets of instructions stored in memory 154 to result in features of audio module 155 such as, for example, a playback application 156 and, optionally, a recording application 157. Playback application 156, which may be controlled by processor 151, may for example be operative to select audio data stored in memory 154 and descriptive of audio information (e.g., one or more audio tracks), responsive to a selection input received from the user or wearer of skullcap headgear 100. Playback application 156 may process the selected audio data and may provide the processed audio data as audio output via output device 153 to the skullcap's wearer. Recording application 157 may be operative to record audio information and store the audio information in memory 154 as audio data.

Audio system 150 may also include a communication module 159 that may be operative to exchange data over a communication network (not shown) with other electronic communication devices (not shown), such as for example a portable or mobile multifunction device like, e.g., a “smart-phone” or other wearable devices. Communication module 159 may be operative to receive from and provide data (e.g., audio data) to such devices, e.g., via wire and/or wireless communication systems (not shown). Communication module 159 may in some embodiments include a Universal Serial Bus (USB) interface enabling the transmission of data from an electronic communication device to memory 154. Input device 152 may include a plurality of sensors labeled by alphanumeric labels 160A-160E. The number of sensors referred to herein should not be construed as limiting. Correspondingly, input device 152 may include fewer or more sensors. One or more of the plurality sensors 160A-160E may be circumferentially arranged along (e.g., adjacent to) rim 105 of skullcap body 101. The angular distance between any two neighboring sensors of the plurality of sensors 160A-160E may be about equal with respect to a geometric center of skullcap 100. In other words, neighboring sensors 160A-160E may be about equidistantly arranged along rim 105 of skullcap body 101 from one another.

Sensors 160A-160E may for example be operative to function based on tactile or optical sensing. Sensors 160A-160E may for example be responsive to the touch or engagement of a finger with any of the sensors.

Sensors 160A-160E may be operatively coupled with processor 151 and memory 154 such that selection inputs made via sensors 160A-160E are associated with respective commands that may be executed by audio module 155. For example, one or more of the plurality of sensors 160A-160E may be associated with a corresponding audio track stored in memory 154. Responsive to an input selection made by the user at, e.g., sensor 160A, audio module 155 may, for instance, select the audio track from a plurality of available audio tracks The selected audio track may be associated with the input selection made at sensor 160A. The selected audio track may then be made audible via output device 153. For example, responsive to an input selection at sensor 160A, a first prayer recitation may be made audible to the user while responsive to an input selection at sensor 160B, and a second prayer recitation may be made audible to the user via output device 153.

According to some embodiments, at least two of the plurality of sensors 160A-160E may each be associated with a group of audio tracks. Responsive to sequentially making a selection input at a given sensor such as, e.g., sensor 160A, audio tracks may be correspondingly selected according a predetermined sequence or looped and provided as audible output to the user via output device 153. One or more of the plurality of sensors 160A-160E may be associated with the functionality of increasing or decreasing the volume of an audio track provided to the user. For instance, making an input selection via sensor 160C may increase the volume of audio tracks played while making an input selection via sensor 160E may decrease the volume of the audible output.

According to some embodiments, at least one or more command functions may be associated with an input selection that is made simultaneously via a plurality of sensors. For example, by simultaneously making an input selection via sensors 160A and 160B, audio system 150 may be put into “hibernation mode”, “sleep mode”, or turned off.

According to some embodiments, audio system 150 may comprise an adjustable calendar and a clock that may be set according to a specific time zone. Based on the time that this currently stored in audio system 150, different data may be accessed by processor 151 when making an input selection via the plurality of sensors 160A-160E. For example, when the current time of a given time zone is set to be within a period, “morning prayer period” during which according to religious laws, morning prayers are recited, playback application 156 may by default make morning prayers audible to the user. On the other hand, when the current time of the selected time zone is set to be within another “evening prayer period”, during which, according to religious laws, evening prayers are recited, playback application 156 may by default make evening prayers audible responsive to a user's input selection.

At least one or a plurality of sensors 160A-160E may be associated with an override function that enables overriding the default selection made by playback application 156. Thus, in response to making an input selection of the override function, playback application 156 may for example make during the morning period an evening prayer audible. Conversely, in response to making an input of selection of the override function, playback application 156 may for example make during an evening period a morning prayer audible.

Input device 152 may further include one or more proximity and/or optical sensors (not shown) that may, for example, be arranged on the underside of skullcap 100 and configured to determine, in operative conjunction with processor 151 and memory 154, whether the underside is accommodated on a correspondingly curved surface. Audio module 155 may in some embodiment only be operative when the underside of skullcap 100 is accommodated on an about correspondingly curved surface. Thus, when skullcap 100 is worn, audio module 155 can be activated and, optionally, initiate the playback of instructions how to operate audio module 155. On other hand, when the skullcap lies on a flat surface, audio module 155 may not be set into operation. This may prevent use of the yarmulke as a learning aid while not being worn by the user.

According to some embodiments, output device 153 may be configured such that earphones (not shown) can be selectively coupled to the device. Alternatively, output device 153 may include earphones.

According to some embodiments, playback application 156 may be operative to selectively mute passages of a text recited by the playback application. The selection of muted passages may be performed in a substantially random or pseudo-random manner. According to some embodiments, selection of muted passages may be made in accordance with a level of proficiency of a user memorizing the text. The level of proficiency may be indicated by the user as a rated input or, alternatively, determined by recording application 157 based on a comparison between speech uttered by the user against data, “text data”, descriptive of a text passage stored in memory 154. The better the speech uttered by the user “by heart” matches the text data, the higher is the level of the user's memorizing proficiency.

According to some embodiments, audio module 155 may be operative to interact via communication device 159 with an electronic communication device. For example, text displayed to a user by the electronic communication device may be made audible by audio module 155 via output device 153. A selection of audio data can be made via the electronic communication device. Audio data may be in some embodiments additionally or alternatively be stored in such electronic communication device.

Reverting to FIGS. 1A and 1B, at least some or all of the components of audio system 150 may be coupled or fixed (e.g., glued) to the inner surface of skullcap body 101. In some other embodiments, at least some or all components of audio system 150 may be, for example, fully or partially embedded between an outer and an inner fabric layer of skullcap body 101. Skullcap body 101 may for instance include a compartment 130 configured to accommodate one or more components of audio system 150. Power module 157, which may include a battery compartment adapted to receive batteries for powering the various components of audio system 150, may for example be accommodated within such compartment of skullcap body 101. The dimensions of compartment 130 may be such that components of audio system 150 or the system in its entirety is fittingly and/or tightly received therein.

Compartment 130 may be equipped with an opening/closure mechanism (not shown) such as, for example, a zipper and/or a snap fastener and/or a button and/or a clasp and/or latch, such that components of audio system 150 are selectively accessible. For example, by unzipping or unbuttoning the opening/closure mechanism, a battery compartment of audio system 150 may become accessible and enable the user unloading and loading the battery compartment with batteries for powering the system.

Skullcap body 101 may include in some embodiments a plurality of compartments for accommodating one or more of the various components of audio system 150.

According to some embodiments, components of audio system 100 may be arranged such that the center of gravity substantially coincides with the geometric center of skullcap body 101. Skullcap 100 comprising skullcap body 101 and comprising audio system 150 which may be incorporated by skullcap body 101 may maximally weight 300 grams, 250 grams, 200 grams, 150 grams or 100 grams.

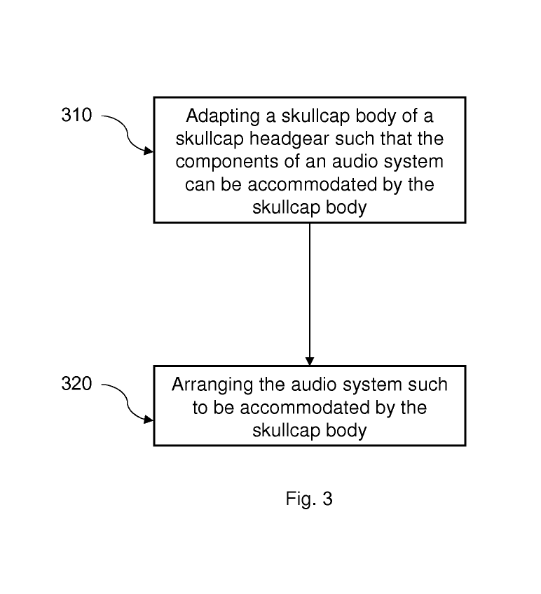

Additional reference is now made to FIG. 3. Aspects of embodiments may relate to a method for manufacturing skullcap headgear 100 comprising skullcap body 101 and audio system 150 that is accommodated by skullcap body 101.

As indicated by block 310, the method may include, for example, adapting a skullcap body, e.g., by providing the skullcap body with one or more compartments such the components of audio system 150 can be accommodated by the skullcap body.

As indicated by block 320, the method may further include, for example, arranging audio system 150 such to be accommodated by the skullcap.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

What is claimed is:

1. A skullcap headgear, comprising:
a skullcap body having a form such to be wearable by a head of a user;
an audio system accommodated by the skullcap body, the audio system comprising:
an input device operative to receive at least one selection input from the user, and
an audio module and a processor for controlling the audio module such to be operative to determine an audible output responsive to the received at least one selection input; and
an output device operative to provide the audible output.

2. The skullcap headgear according to claim 1, wherein the skullcap body has the form of a spherical cap covering an area smaller than that of a hemisphere.

3. The skullcap headgear according to claim 1, wherein the input device comprises a plurality of sensors that are arranged circumferentially along a rim of the skullcap body and that are responsive to the received at least one selection input.

4. The skullcap headgear according to claim 3, wherein each of the plurality of sensors is operative to sense a selection input associated with at least one command for execution by the audio module.

5. The skullcap headgear according to claim 1, wherein the audio system further comprises a memory for storing data that is descriptive of a plurality of audio tracks.

6. The skullcap headgear according to claim 1, wherein the audio module is operative to record and store audio information.

7. The skullcap headgear according to claim 1, wherein the audio system comprises a power source operative to power the processor, the input device, the output device and the audio module.

8. The skullcap headgear according to claim 1, wherein the skullcap body has one or more compartments configured to receive the audio system.

9. The skullcap headgear according to claim 1, wherein the audio system is incorporated in the skullcap body such that the center of gravity of the skullcap headgear coincides substantially with the geometric center of the skullcap body.

10. The skullcap headgear according to claim 1, wherein the skullcap headgear weighs maximally 300 grams.

11. The skullcap headgear according to claim 1, wherein the skullcap headgear is a yarmulke or kippa.

12. A skullcap headgear, comprising:
a skullcap body having a form such to be wearable by a head of a user;
an audio system accommodated by the skullcap body, the audio system comprising an input device operative to receive at least one selection input from the user and a plurality of sensors arranged circumferentially along a rim of the skullcap body that are responsive to the at least one selection input;
an audio module and a processor for controlling the audio module such as to be operative to determine an audible output responsive to the received selection input; and
an output device operative to provide the audible output.

13. The skullcap headgear according to claim 12, wherein the skullcap headgear is a yarmulke or kippa.

14. A method for manufacturing a skullcap headgear comprising a skullcap body, the method comprising:
adapting a skullcap body such that an audio system can be accommodated by the skullcap body; and
accommodating the audio system in the skullcap body.

15. The method according to claim 14, wherein the adapting a skullcap body comprises providing the skullcap body with one or more compartments for receiving the audio system.

16. The method according to claim 14, further comprising arranging the audio system such to be accommodated by the one or more compartments.
